(19) United States
(12) Patent Application Publication
(10) Pub. No.: US 2019/0392503 A1
(43) Pub. Date: Dec. 26, 2019

(54) SYSTEM, METHOD, and COMPUTER PROGRAM FOR PROVIDING USER MAXIMUM BENEFIT IN ELECTRONIC COMMERCE

(71) Applicant: PIGGY LLC, Lake Mary, FL (US)

(72) Inventors: Nicholas Corrieri, Sartell, MN (US); John Ginsberg, Southend-on-Sea (GB); Nicholas Mahalec, Santa Monica, CA (US)

(21) Appl. No.: 16/133,197

(22) Filed: Sep. 17, 2018

Related U.S. Application Data
(63) Continuation-in-part of application No. 15/606,856, filed on May 26, 2017.
Application No. 15/606,856 is a continuation-in-part of application No. 15/261,733, filed on Sep. 9, 2016.
(60) Provisional application No. 62/559,164, filed on Sep. 15, 2017.
(60) Provisional application No. 62/216,111, filed on Sep. 9, 2015.

(51) Int. Cl. G06Q 30/06

(52) U.S. Cl. CPC G06Q 30/0629; G06Q 30/0633

(57) ABSTRACT

The present invention generally relates to a system, method, and computer program for providing maximum savings in electronic commerce. Specifically, during a shopping experience, several products or service inputs, such as: electronic coupon codes, sales taxes, cashback rebates, etc. are calculated and compared against numerous competitor retailer stores to ascertain the lowest price.

### CLAIM OF PRIORITY

The present application claims priority to U.S. Provisional Application No. 62/559,164, filed on Sep. 15, 2017, and is a continuation-in-part patent application of previously filed and now pending application having application Ser. No. 15/606,856 filed on May 26, 2017, which is a continuation-in-part patent application of previously filed, now pending application having application Ser. No. 15/261,733, filed on Sep. 9, 2016, which claims priority to U.S. Provisional Application No. 62/216,111, filed on Sep. 9, 2015, the disclosure of which is explicitly incorporated by reference herein, in its entirety.

### BACKGROUND OF THE INVENTION

### Field of the Invention

The present invention generally relates to systems, methods, and computer programs for providing the maximum user benefit to a user in electronic commerce. Specifically, multiple price factors are used to compare products and services of various e-commerce merchants in order to automatically alert the user to the best possible price during a shopping experience.

### Description of the Related Art

Electronic commerce (“e-commerce”) generally utilizes the internet to conduct retail transactions, or “e-commerce transactions.” Most e-commerce websites do not provide the user with information regarding competitor's goods or services. If the user would like to compare product or service information between various merchants (e.g., price) he/she would have to visit each website or open each native application, which takes time. In addition, it would take even more time to calculate the lowest “net” price (i.e., base price+/−taxes, shipping costs, electronic coupon code savings, cashback savings, etc.) of each product or service. As such, there is a need in the art for an automated solution. The present invention answers such a need, and provides several additional benefits to consumers in order to facilitate e-commerce transactions.

### SUMMARY OF THE INVENTION

The present invention is generally directed to providing to maximum benefit to a user in electronic commerce and accompanying systems, methods, and computer programs thereof. The preferred embodiment of the present invention facilitates the provision of a maximum benefit in electronic commerce (“e-commerce”) settings, such as retail websites and downloadable applications. More specifically, products and/or services of various e-commerce merchants will be automatically compared in order to alert the user to his/her maximum benefit, such as lowest price. In order to compare a product or service of various e-commerce merchants and find the lowest price, multiple inputs may be included, such as but not limited to, availability, price, taxes, fees, electronic coupon codes, rebates or cash back, etc. Accordingly, the user may save money on the purchase of any conceivable e-commerce product or service, including activities, tours, hotel rooms, car rentals, etc. This can be done on exact matches of a product or service, or on a similarity match for the product or service, as described in greater detail below.

As such, the preferred embodiment may comprise a browser “plug-in,” or background service, whether in a desktop, mobile, or wearable electronic operating system, which may be implemented for tracking the current website or application the user is viewing and automatically providing him/her with a lower priced option, as described in greater detail below. For example, in a browser plug-in embodiment, a URL or URI may be tracked, and upon a change or a user's visit to a recognized store, at least one input may be sent by the browser plug-in to an application server communicating with the plug-in.

For purposes of clarity and without limiting the scope of the present invention, this embodiment may be described as being implemented with a web browser (e.g., mobile, desktop, etc.) for accessing information on the world wide web. More specifically, accessing retail websites or web pages that are identified by a distinct identifier, such as a URL, enabling the web browser to retrieve and display them on the user's device. However, it is emphasized that this embodiment can be operable with downloadable applications (e.g., mobile apps, desktop apps, etc.) which do not require a URL or access to the world wide web, or on websites through some other means of identifying what product, hotel, flight, service, activity, or other type of listing is being presented to the user on the page.

An algorithm may be implemented in order to detect a website URL or other e-commerce interface identifier or certain product and/or service information, or determine the type of retail store, and accordingly access various data fields, preferably in a uniform format across different stores, in order to determine which input(s) to retrieve from the e-commerce website or application that the user is viewing (this is typically, but not always, initiated when the user is at a “checkout” process—the area of the website or application which allows the user to initiate and/or complete an e-commerce transaction).

DOM parsing rules may be implemented, for example, to access various fields from the website or application via JavaScript code. Individual algorithms may be implemented for different proprietary websites or applications (such as Amazon.com and other large retailers), as well as available out-of-the-box electronic commerce solutions or stores such as Joomla, Magenta, or Wordpress plugins, Shopify, Volusion, Bigcommerce, bigcartel, 3dcart, Squarespace, and the like. Each algorithm specific to a particular store may be established by reverse engineering an existing online store and/or store shopping cart, such as to securely retrieve, submit, and validate responses to the data fields within the online store and/or shopping cart. Certain stores may require the redaction of prices of items, charges for the quantity of shipping, etc., in order to obtain a set of usable data fields for the application server, and as such, the present invention may be configured to comply with same.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a diagrammatic representation of an exemplary application and implementation environment for providing maximum benefit in electronic commerce of the present invention.

FIG. 2 is another exemplary user interface of an application for providing maximum benefit in electronic commerce of the present invention, illustrating end user functionality.

FIG. 3 is another exemplary user interface of an application for providing maximum benefit in electronic commerce of the present invention, illustrating end user functionality.

FIG. 4 is another exemplary user interface of an application for providing maximum benefit in electronic commerce of the present invention, illustrating end user functionality.

FIG. 5 is another exemplary user interface of an application for providing maximum benefit in electronic commerce of the present invention, illustrating end user functionality.

Like reference numerals refer to like parts throughout the several views of the drawings.

### DETAILED DESCRIPTION OF THE PREFERRED EMBODIMENT

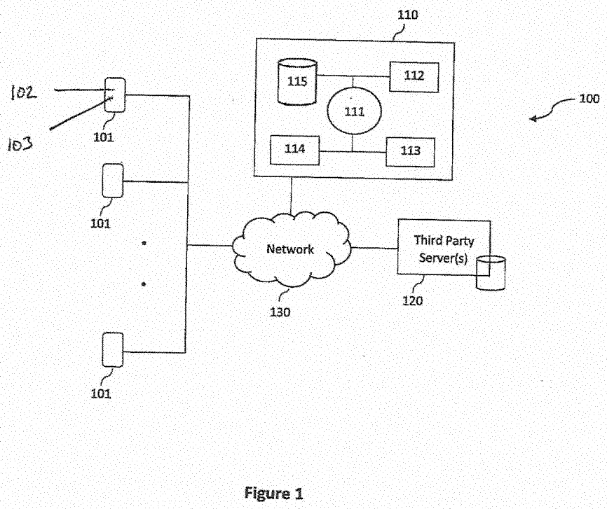

The present invention may be implementable on an application server in a software-as-a-service (SaaS) mobile application, or desktop application environment in accordance with implementation on a system or application 100 as generally represented in FIG. 1. Accordingly, the system 100 of the present invention generally comprises at least one client device 101 communicably connected to at least one application server 110 over a network 130. One or more third party server(s) 120 may further be communicably connected to the application server 110 and the at least one client device 101 over the same network 130.

The client device 101 may comprise a mobile device, tablet, computer, wearable electronic device, or any other device or combination of circuits structured and configured to communicate with another device, computer, or server over the network 130. The client device 101 may comprise application(s) and user interface(s) (front-end interface) that allows a user to interact with the application server(s) 110 and any third-party server(s) 120 and stored applications and programs thereon (back-end processing). The user interface may be proprietary and may comprise a custom developed mobile or desktop application(s). Alternatively, or in addition to, the user interface may comprise a web browser (including mobile browsers designed for use on a mobile device) or other application or executable code that allows for communication and visualization of information.

The term “application server” 110, “third party server” 120 refer to at least one computer having appropriate hardware and applications installed thereon for the provision of server services including web and other functional services described herein, such that a user may access, execute, and/or view the applications remotely from a client device 101. More specifically, the application server(s) 110 and third-party server(s) 120 may comprise general-purpose computers, specialized computers, or other hardware components structured and configured to receive, process, transmit, and store information to and from other devices. The application server 110 is further configured with executable or interpretable computer code that allows it to perform the processes described within this application.

For example, the application server 110 may comprise a general-purpose computer comprising a central processing unit (CPU) 111, which may be a single core or multi core processor, memory 114 (random-access memory, read-only memory, and/or flash memory) or primary memory for high-speed storage of executing programs, electronic storage unit 115 (e.g., hard disk) or secondary memory for storing data, communications interface 112 (e.g., network adapter) for communicating with other devices or computers over a network, and/or peripheral device(s) 113 in communication with the CPU 111 that enable input/output of the application server 110.

The application server 110 may implement the methodology of the present invention using any number of solution stacks (a set of software subsystems or components) known to an ordinary computer or web programmer skilled in the art. These solution stacks may include, without limitation, ZEND Server, APACHE Server, NODE.JS, ASP, PHP, Ruby, XAMPP, LAMP, WAMP, MAMP, WISA, LEAP, GLASS, LYME, LYCE, OpenStack, Ganeti, MEAN, MEEN, XRX, JAVASCRIPT and other past, present, or future equivalent solution stacks, or combinations thereof, known to those skilled in the art that allows a programmer to develop the methods and computer programs described within this application. The software stack might be implemented without third-party cloud platforms, for example using load balancing and virtualization software provided by Citrix, Microsoft, VMware, Map-Reduce, Google Filesystem, Xen, memory caching software such as Memcached and Membase, structured storage software such as MySQL, MariaDB, XtraDB, etc. and/or other appropriate platforms. Of course, these solution stacks may also be deployed in cloud platforms by using known development tools and server hosting services such as GitHub and Rackspace, as well as their equivalents.

The third-party server(s) 120 may comprise any combination of hardware and software (code segments in any number of programmable, executable, or interpretable languages that support the functionality of the methods described herein) configured to host and transmit items of a user. The third-party server(s) 120 may be configured to communicate directly to the application server 110 via application programming interfaces or upon the request of a user.

User account services may be implemented using one or more solution stacks as described above. Alternatively, third-party login services such as Facebook, Twitter, LinkedIn, Google and other related services, may be utilized for user account login and authentication, such as via existing third-party server(s) 120 of other parties.

The network 130 may comprise at least two computers in communication with each other, which may form a data network such as via LAN, WAN, Serial, Z-WAVE, ZIGBEE, RS-485, MODBUS, BACNET, the Internet, or combinations thereof. The connections may be facilitated over various wired and/or wireless mediums or any combination thereof including interconnections by routers and/or gateways. Network 130 may comprise additional hardware components and/or devices appropriate for facilitating the transmission and communication between the various systems and devices of the present invention, such as those directed to integrated authentication, quality control or to improve content delivery such as via a content delivery network (CDN).

Various aspects of the present invention may be thought of as “products” or “articles of manufacture” typically in the form of machine (or processor) executable code, interpretable code, and/or associated data that is carried on or embodied in a machine readable medium. Machine-executable code can be stored on an electronic storage unit, such memory (e.g., read-only memory, random-access memory, flash memory) or a hard disk, as described above.

All or portions of the software may at times be communicated through the Internet or other communication networks. Such communications, for example, may enable loading of the software from one computer or processor onto another, for example, from a management server or host computer onto the computer platform of an application server, or from an application server onto a client computer or device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, tangible “storage” media, terms such as computer or machine “readable medium”, refer to any medium that participates in providing instructions to a processor for execution. Further, the term “non-transitory” computer readable media includes both volatile and non-volatile media, including RAM. In other words, non-transitory computer media excludes only transitory propagating signals per se, but includes at least register memory, processor cache, RAM, and equivalents thereof.

Therefore, a machine-readable medium, such as computer-executable code and/or related data structures, may take many forms, including but not limited to, a tangible storage medium, a carrier wave medium or physical transmission medium. Non-volatile storage media include, for example, optical, magnetic, or solid-state disks, such as any of the storage devices in any computer(s) or the like, such as may be used to house the databases. Volatile storage media include dynamic memory, such as main memory of such a computer platform. Tangible transmission media may include coaxial cables, copper wire and fiber optics, communication buses. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

A web browser or downloadable application may embed and/or access a plug-in or extension 103. As known in the art, an extension may be implemented in different forms, including a callable script implemented using a scripting language, such as JavaScript. For example, a web browser 102 may call or invoke a script built and injected into a webpage and loaded by a browser-type application. As discussed hereinafter, an extension 103 may communicate with the application server 110 so as to send and retrieve e-commerce information relating to products and services of merchant e-retailers.

A client device 101 may include device specific storage functionality such as local storage capable of storing certain e-commerce information. For example, device local storage may be configured to store a plurality of electronic coupon codes or response data to codes checked against a website or application's “checkout page”. However, local storage is not a necessary requirement of the present invention; e-commerce information, such as a plurality of coupon codes, may be stored and applied directly from the application server 110.

In the preferred embodiment, the present invention may be implementable on the application server 110 in a desktop or mobile environment in accordance with implementation on an application 100 as represented in FIG. 1. Once downloaded to the user's mobile or desktop device 101, the present invention will automatically detect when the user has initiated a shopping experience and activate. As such, it will not be necessary for the user to ‘open’ the present invention on his/her mobile or desktop device 101 prior to, or during, the shopping experience. This feature will save the user time and reduce “click counts” in their shopping experience, which will allow users to complete purchases faster which increases the chances for a sale.

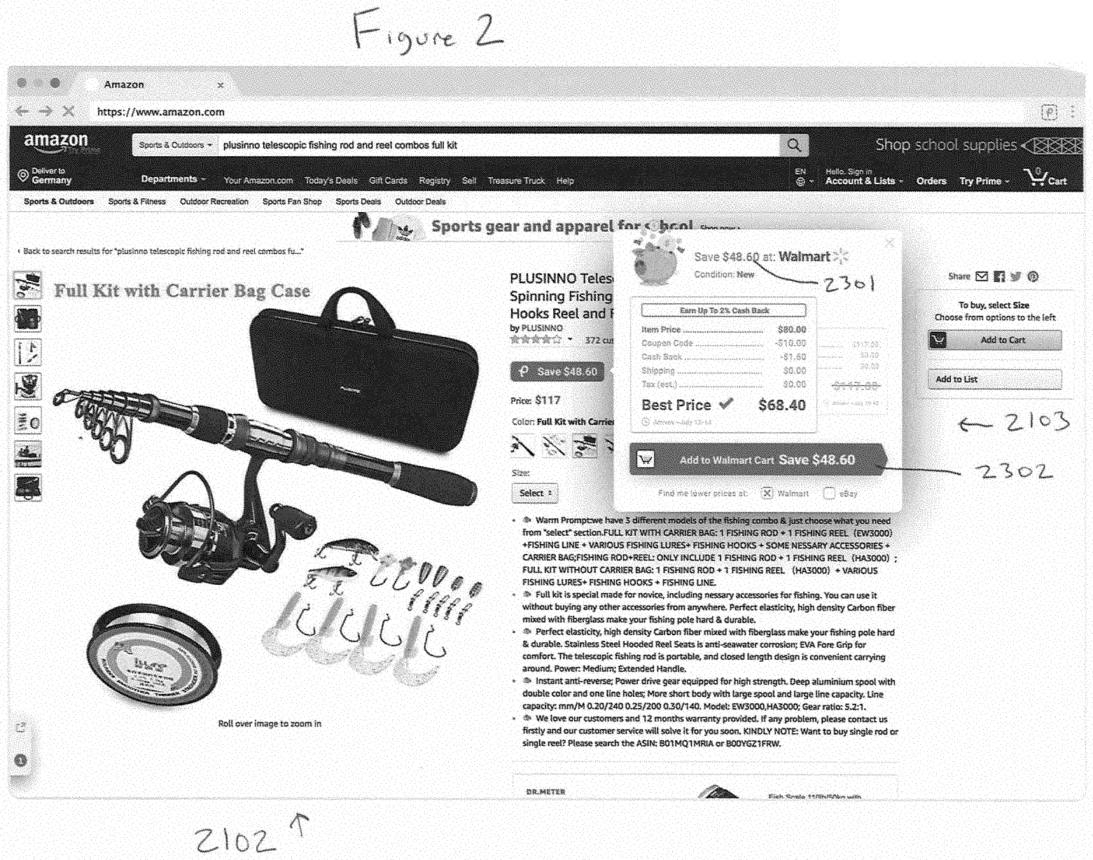

Drawing attention to FIGS. 2-5, embodiments of the present invention are illustrated from an end user's perspective. In order to begin a shopping experience, a user may initially navigate to or open a target e-commerce interface 2102 of a target merchant ‘store’. More specifically, the target e-commerce interface 2102 of a target merchant store may comprise the target merchant store's website, such as a mobile website, or a native downloadable application, such as a native mobile application. Accordingly, for purposes of clarity and without limiting the scope of the present invention, this invention will be described with reference to the target e-commerce interface 2102 and a competing e-commerce interface 2202 of at least one competing merchant store being implemented in a desktop environment using a web browser. However, it is emphasized that the target e-commerce interface 2102 and/or the competing e-commerce interface 2202 of the at least one competing merchant store can be operable in addition to and other than a desktop environment (e.g., mobile web or native application environment).

Further, after the user navigates to or opens the target e-commerce interface 2102, the application 100 automatically detects when the user is viewing at least one product or service and automatically captures certain information, such as but not limited to, the product or service item listing. The item listing may contain specific information about the product or service and general information about the target e-commerce interface 2102, which can be sent as parameters to the application server 110 in order to validate that the target e-commerce interface 2102 is supported by the application server 110. If supported, the application server(s) 110 may compare the item listing(s) with item listing(s) of other e-commerce merchant ‘stores’ in order to find the lowest price available, as described in greater detail below. The item listing may include any conceivable product or service that the user is viewing during the shopping experience, including travel services for booking hotels, airfare, tours, etc.

For purposes of clarity and without limiting the scope of the present invention, this invention will be described with reference to an item price of an item listing being the current lowest price of said product or service after all price factors have been applied to the base price of same. As such, an item price may include price factors such as, but not limited to, sales tax amount, shipping cost amount, vendor fees amount, resort fees amount, coupon savings, cashback or rebate savings, or any combination of the above.

It should be noted that a key component of any online transaction cost is sales taxes and shipping costs. In order to properly (and automatically) calculate these items, the user's location needs to be determined. In one embodiment, the user's location may be determined based on the IP address of his/her client device 101. In another embodiment, the user's location may be determined based on his/her preferred shipping address, which may or may not be visually visible on the merchant website or application. After determining the location, the sales tax and shipping costs can be determined without requiring the user to navigate to the competing merchant store. This is unique because sales taxes and shipping costs may vary from merchant to merchant depending on the merchant's location relative to the user (e.g., due to sales tax nexus, lower shipping costs due to warehouse location, etc.). Further, this may be accomplished in a “background” process, hidden from what the user can visually see on the screen.

As an example, referencing the hypothetical table below, Competing Merchant C has the highest base price of the competing merchants, but after applying the cashback savings and coupon savings, the present invention has automatically calculated that the lowest item price would currently come from Competing Merchant C. In addition, since Competing Merchant A and Competing Merchant B also have a lower item price than the Target Merchant, the present invention may retrieve and display all three item listings of the Competing Merchants to the client device 101.

| | Base | | | Item | Total |
|---|---|---|---|---|---|
| Vendor | Price | Cashback | Coupon | Price | Benefit |
| Target | $110 | 0% | $0 | $110 | $0.00 |
| Merchant | | | | | |
| Competing | $100 | $5 | $0 | $95 | $5.00 |
| Merchant | | | | | |
| A | | | | | |
| Competing | $101 | 5% | $5 | $90.95 | $19.05 |
| Merchant | | | | | |
| B | | | | | |
| Competing | $102 | 10% | $5 | $86.80 | $23.20 |
| Merchant | | | | | |
| C | | | | | |

In one embodiment, the application 100 may provide the user with various item price factors (tax amount, etc.) that allows the user to manually select what he/she would like the item price to include prior to comparison.

Each item listing may comprise an e-commerce interface identifier and certain product and/or service information, such as but not limited to: item code, including a product or service identifier; product ID code; service ID code; UPC code; SKU code; product name; service name; item state (e.g., a new or used product); URL information (if a website is used); base price; check in date; check out date; hotel name; hotel address; hotel location based on a map; hotel star rating; customer ratings; user reviews; flight number; airline; departure date and time; arrival date and time; car rental pickup date and time; car rental drop-off date and time; car rental supplier; car rental provider; car rental category; car rental type; car make and model; number of travelers; number of passengers; number of bags; number of large bags; number of small bags; departure airport; layover airport; arrival airport; activity name; activity start date and time; activity end date and time; activity location; tour name; tour date; shipping from location; room type; number of beds; bed type; number of guests; number of adults; number of children; number of nights; room category; room name; cancellation policy; and latest cancellable date.

If the target e-commerce interface 2102 is supported by the application 100, the application 100 may automatically compare at least one item listing of the target merchant store with the item listing of at least one competing merchant store in order to determine whether a lower price exists for the product(s) and/or service(s). More specifically, the application server 110 may compare whether the item listing from at least one competing merchant store has a lower item price than the item listing from the target merchant store for the same product(s) and/or service(s). If the target merchant store's item listing has the lowest item price, the application 100 may remain hidden to the user. However, if the item listing from at least one competing merchant store has a lower item price, the application 100 may automatically retrieve the lower-priced item listing(s) and display a message on the client device 101 in order to alert the user.

In at least one embodiment, the present invention may automatically retrieve an item listing from at least one competing merchant store that is similar to, but not the same as, the item listing from the target merchant store. More specifically, if a lower-priced item listing from at least one competing merchant store is found, it will typically be an exact match of the product or service that the user is viewing in the target merchant store (for example, an exact match may be matching the item codes of two televisions). However, a competing merchant store may not have the exact product or service, but does have a “similar” product or service (or has a lower-priced similar product or service in addition to the exact product or service). For example, a television brand may sell one unique model through Walmart and another unique model through Best Buy, but said models may have slight differences (such as one model including an additional HDMI port) and as such, have different item codes. Accordingly, if a “similar” item listing from at least one competing merchant store has a lower item price than the item listing of the target merchant store, the application 100 may automatically retrieve the “similar” item listing(s) to display on the client device 101 in order to alert the user.

The application 100 may detect, capture, calculate, compare, and retrieve the item listing(s) within a background process, hidden to the user. In one embodiment, the application 100 may prompt the user to ‘manually’ detect, capture, compare, and/or retrieve the item listing(s), via an interactive button.

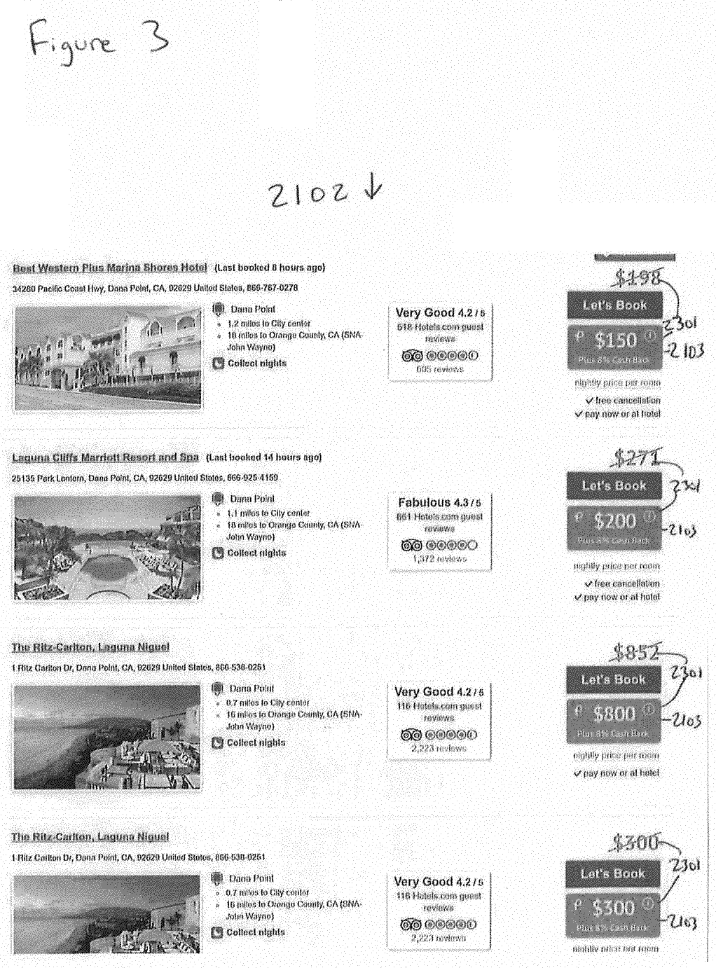

As illustrated in FIGS. 2-3, when the application 100 determines that the item listing(s) from the at least one competing merchant store has a lower item price than the target merchant store, the application 100 may automatically display said item listing(s) within the target e-commerce interface 2102. This ‘display’ within the target e-commerce interface 2102 may be facilitated by a plug-in or extension 2103 that may appear dormant until being ‘activated’ by the application 100 and automatically “injected” into the native application or browser. More specifically, upon retrieval of a lower-priced item listing(s), the dormant or embedded extension 2103 may be automatically activated and displayed into the already loaded target e-commerce interface 2102. Moreover, the extension 2103 may be slid or injected into the target e-commerce interface 2102 in order to alert the user to possible savings at another store.

The extension 2103, may comprise at least one interactive user interface element, such as a button, take various shapes and colors, and be injected into different areas of the target e-commerce interface 2102 in order to best alert the user to possible savings. The extension 2103 may include a price compare message 2301 to alert the user that the application 100 has provided at least one lower-priced item listing. The price compare message 2301 may comprise an interactive button to allow the user to select the lower-priced item listing. As illustrated in FIG. 3, if the user is viewing multiple item listings in the target e-commerce interface 2102, the application 100 may retrieve and display multiple extensions 2103 injected therein.

The application server 110 may retrieve and display the item listing of the at least one competing merchant store directly into the target e-commerce interface 2102. If the application 100 retrieves multiple item listings from the at least one competing merchant store, it may rank the retrieved item listings sequentially from lowest item price to highest item price. This may allow the user to “swipe” through the ranked item listings of the at least one competing merchant store, for example one by one, to view all options before making a selection. Moreover, if the user is shopping on a client device 101 that comprises a small screen (e.g., cell phone), it may not be optimal to display all ranked item listings due to the small-screen size. Upon navigation to a different item listing, the application 100 will repeat the above steps.

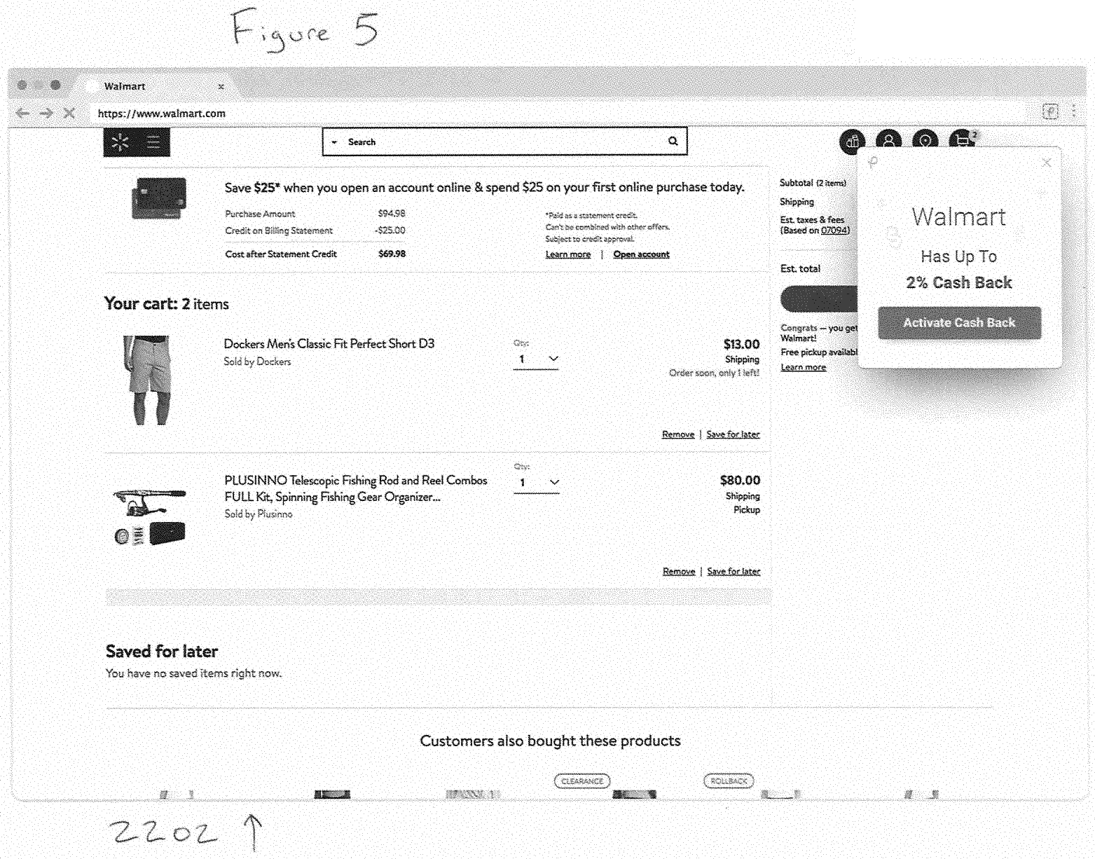

As illustrated in FIG. 3, the application 100 may automatically display at least one extension 2103, each representing a retrieved item listing of an associated competing merchant store. Each extension 2103 may comprise an interactive button, such as the price compare message 2301 in order to prompt the user to select the displayed item listing of the at least one competing merchant store. Upon selection of the price compare message 2301 button, the application 100 may automatically redirect the user to the competing e-commerce interface 2202 (illustrated in FIG. 5) associated with said competing merchant store, in order to initiate an e-commerce purchase.

As illustrated in FIG. 2, in another embodiment, the application 100 may automatically display the extension 2103 representing a retrieved item listing of the associated competing merchant store. The extension 2103 may comprise an interactive button, such as the “Add to Cart” button 2302 in order to prompt the user to select the displayed item listing of the at least one competing merchant store. By selecting the “Add to Cart” button 2302, representing the lower-priced item listing of the associated competing merchant store, the application 100 may automatically apply the item listing into the associated competing e-commerce interface 2202, in a background process hidden to the user.

More specifically, the selected item listing of the competing merchant store may be automatically applied into the associated competing e-commerce interface 2202, in a background process that may be hidden to the user, to allow the user to continue the shopping experience prior to initiating an e-commerce purchase. The competing e-commerce interface 2202 may comprise the competing merchant store's website, including a mobile website, or a native application, including a native mobile application. Accordingly, for purposes of clarity and without limiting the scope of the present invention, this invention will be described with reference to the competing e-commerce interface 2202 being in the form of a desktop website. However, it is emphasized that the competing e-commerce interface 2202 of the present invention can be operable in addition to and other than a desktop website. Moreover, the competing e-commerce interface 2202 may be in the form of a native mobile application, a mobile website, or a desktop application.

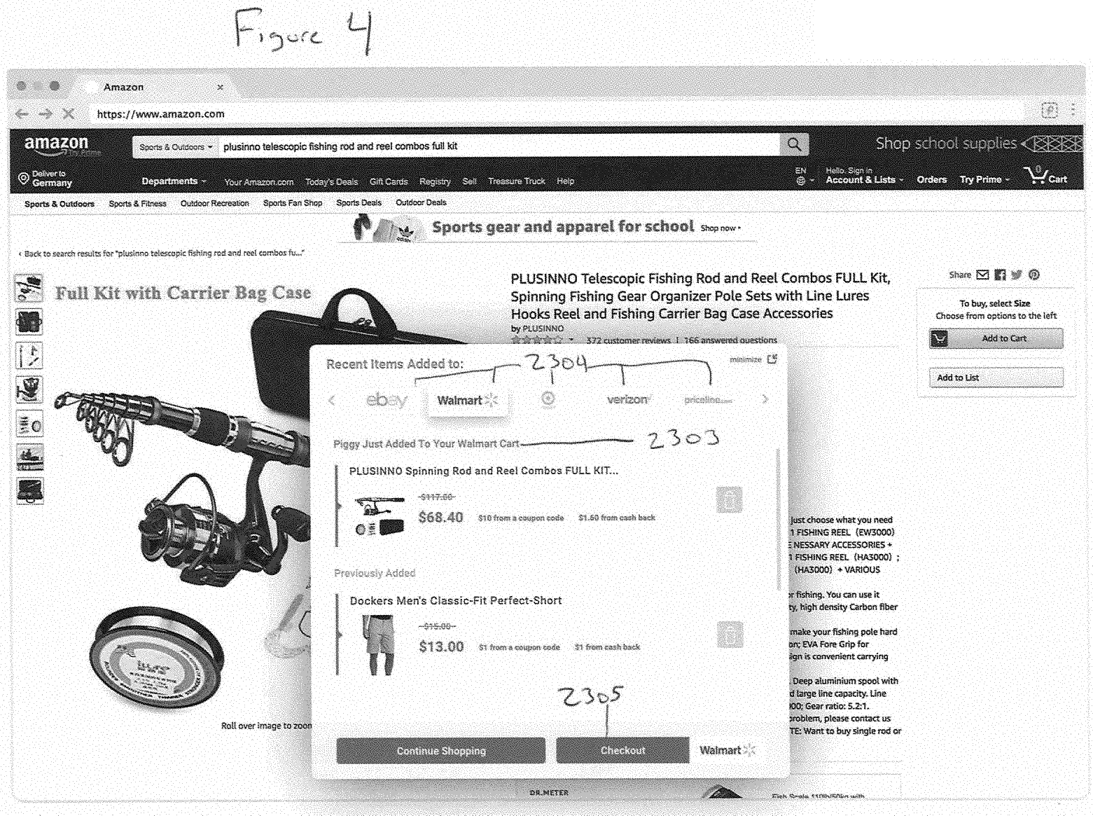

The application 100 may apply the selected item listing of the at least one competing merchant store into the associated competing e-commerce interface's 2202 “virtual shopping cart” and display a reference to the applied item listing(s) within the target e-commerce interface 2102. For example, and as illustrated in FIG. 4, the application 100 may comprise a cart message 2303 indicating that the application 100 has applied at least one item listing into the competing e-commerce interface 2202 of the at least one competing merchant store. The cart message 2303 may comprise listing item information, such as the item price and the name of the competing merchant store. In one embodiment, the application 100 may prompt the user to view the “virtual shopping cart”, via an interactive user interface element, such as a “See Cart” button 2304, in order to view all the selected item listings contained in each “virtual shopping cart”.

In another embodiment, the application 100 may apply the selected item listing(s) into the associated competing e-commerce interface's 2202 “electronic shopping cart” and/or “checkout area”. As such, if the user independently (for example, not via the application 100) navigates to the associated competing e-commerce interface 2202, the selected item listing(s) may still be applied therein. A “checkout area” may at least partially comprise a web or native application ‘page’ wherein the user is able to initiate an e-commerce purchase.

As illustrated in FIG. 4, the application 100 may prompt the user to redirect to the competing e-commerce interface 2202 to initiate an e-commerce purchase. The application 100 may prompt the user to redirect to the associated competing e-commerce interface 2202, via an interactive user interface element, such as a “Checkout” button 2305, in order to initiate an e-commerce purchase.

As illustrated in FIG. 5, upon redirection to the competing merchant interface 2202, the user may complete his/her e-commerce purchase. If the user has selected item listings from multiple competing merchant stores, the application 100 may direct the user to each competing e-commerce interface 2202 in order to complete all e-commerce purchases for the selected item listings. In one embodiment, after completing an e-commerce purchase at a competing e-commerce interface 2202, the application 100 may redirect the user back to the target e-commerce interface 2102 and prompt the user to ‘manually’ direct, via an interactive button, to the next competing e-commerce interface 2202 to initiate an e-commerce purchase therein.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for providing e-commerce information associated with an e-commerce transaction, to users of an electronic device comprising:
detecting automatically at least one item listing of a target merchant store in a target e-commerce interface;
displaying automatically the at least one item listing of at least one competing merchant store within the target e-commerce interface;
prompting the user automatically to select the at least one item listing of the at least one competing merchant store within the target e-commerce interface;
applying automatically the at least one item listing of the at least one competing merchant store to a competing e-commerce interface associated with the at least one competing merchant store; and,
configuring at least one application server to include at least one database having e-commerce information associated with a plurality of e-commerce interfaces.

2. The method of claim 1 wherein the target e-commerce interface comprises a website of the target merchant store.

3. The method of claim 2 wherein the website of the target merchant store comprises a mobile website of the target merchant store.

4. The method of claim 1 wherein the target e-commerce interface comprises a native application of the target merchant store.

5. The method of claim 4 wherein the application of the target merchant store comprises a native mobile application of the target merchant store.

6. The method of claim 1 wherein the at least one item listing comprises an item code.

7. The method of claim 6 wherein the item code comprises a product identifier.

8. The method of claim 6 wherein the item code comprises a service identifier.

9. The method of claim 1 wherein the at least one item listing comprises an e-commerce interface identifier.

10. The method of claim 1 wherein the at least one item listing comprises an item price.

11. The method of claim 10 wherein the item price comprises a tax amount.

12. The method of claim 10 wherein the item price comprises a shipping cost amount.

13. The method of claim 10 wherein the item price comprises a vendor fees amount.

14. The method of claim 10 wherein the item price comprises a resort fees amount.

15. The method of claim 10 wherein the item price comprises coupon savings.

16. The method of claim 10 wherein the item price comprises a cashback savings.

17. The method of claim 1 further comprising:
capturing automatically the at least one item listing of the target merchant store;
transmitting automatically the at least one item listing of the target merchant store to at least one application server;
comparing automatically the at least one item listing of the target merchant store with the item listing of at least one competing merchant store to determine whether the item listing of the at least one competing merchant store has a lower item price than the item listing of the target merchant store; and
retrieving automatically the item listing of the at least one competing merchant store from the application server.

18. The method of claim 17 further comprises retrieving multiple item listings of the at least one competing merchant store from at least one application server.

19. The method of claim 1 wherein applying the at least one item listing of the at least one competing merchant store further comprises automatically applying the at least one item listing of the at least one competing merchant store into a checkout area of the at least one competing merchant store.

20. The method of claim 1 wherein applying the at least one item listing of the at least one competing merchant store further comprises automatically applying the at least one item listing of the at least one competing merchant store into an electronic shopping cart containing the at least one item listing of the at least one competing merchant store.

21. The method of claim 1 wherein applying the at least one item listing of the at least one competing merchant store further comprises automatically applying the at least one item listing of the at least one competing merchant store into a virtual shopping cart containing the at least one item listing of the at least one competing merchant store.

22. The method of claim 21 further comprises prompting the user to view the virtual shopping cart within the target e-commerce interface.

23. The method of claim 1 further comprising redirecting the user to the competing e-commerce interface associated with the at least one competing merchant store.

24. The method of claim 23 wherein redirecting the user further comprises prompting the user to redirect from the target e-commerce interface to the competing e-commerce interface.

25. The method of claim 23 wherein redirecting the user further comprises automatically redirecting the user from the target e-commerce interface to the competing e-commerce interface.

26. The method of claim 1 wherein the competing e-commerce interface comprises a website of the at least one competing merchant store.

27. The method of claim 26 wherein the website of the at least one competing merchant store comprises a mobile website of the at least one competing merchant store.

28. The method of claim 1 wherein the competing e-commerce interface comprises a native application of the at least one competing merchant store.

29. The method of claim 28 wherein the application of the at least one competing merchant store comprises a native mobile application of the at least one competing merchant store.
